(19) United States
(12) Patent Application Publication
(10) Pub. No.: US 2004/0135388 A1
(43) Pub. Date: Jul. 15, 2004

(54) Tweezers holder

(76) Inventors: Christian Sgobero, Montignez (CH); Richard Sgobero, Montignez (CH)

Correspondence Address: YOUNG & THOMPSON, 745 SOUTH 23RD STREET 2ND FLOOR, ARLINGTON, VA, 22202

(21) Appl. No.: 10/468,518

(22) PCT Filed: Feb. 15, 2002
(86) PCT No.: PCT/IB02/00458

(30) Foreign Application Priority Data
Feb. 19, 2001 (EP) 01103935.1

(51) Int. Cl. B25J 15/12

(52) U.S. Cl. 294/100

(57) ABSTRACT

A gripper for tweezers includes a case (1) intended to be mounted on a robot arm, enclosing (i) a tweezers fixing and indexing device (6-14) and (ii) a device for controlling the arms of the tweezers. The control device includes a motor element (4, 17) which controls the pushing devices (21) that act on the arms of the tweezers.

More and more, the operations of handling, positioning, and generally speaking all manual operations, tend to be automated and robotized. In numerous applications, for timekeeping, medicine, research, etc., these manual operations are carried out with the help of tweezers. To be able to automate or robotize such manual operations using tweezers, it is necessary, as with many tools that have tool carriers, to have tweezers carriers permitting establishing a mechanical connection between a robot and one or several tweezers and also permitting actuation of these tweezers by the robot.

The present invention has for its object the provision of a gripper or tweezers holder adapted to be mounted on the movable member of a robot and capable of receiving a pair of tweezers and actuating the latter for gripping, orienting, transporting and positioning of objects to be manipulated with tweezers. Such a gripper in fact constitutes a mechanical interface between a robot and a pair of tweezers which thus permits automating and robotizing all sorts of operations at present carried out manually with tweezers.

The present invention has for its object a gripper or tweezers holder adapted to be mounted on a movable member of a robot and adapted to receive tweezers and to actuate them, which is distinguished by the characteristics set forth in claim 1.

The accompanying drawings illustrate schematically and by way of example an embodiment of tweezers holder according to the invention.

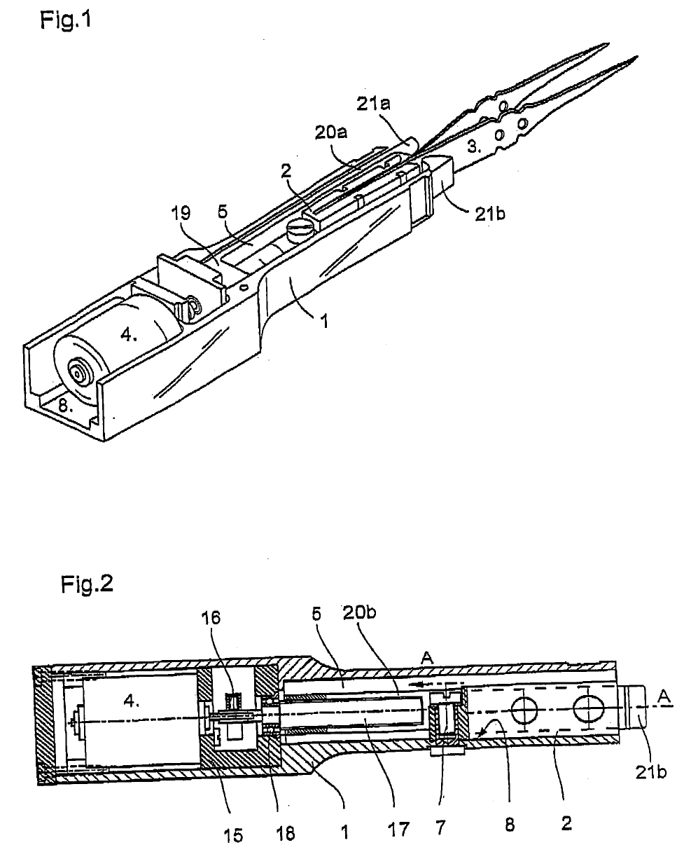

FIG. 1 is a perspective view of the tweezers holder.

FIG. 2 is a longitudinal cross-section of the tweezers holder.

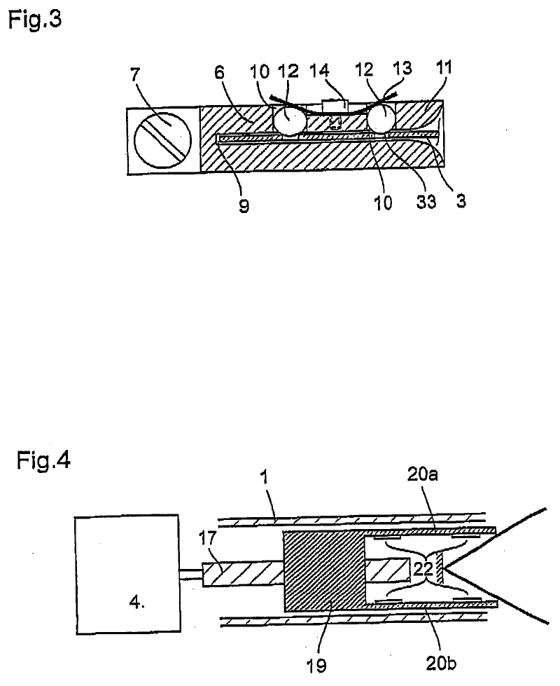

FIG. 3 shows in cross-section on the line A-A of FIG. 2 the device for securing tweezers in the tweezers holder.

FIG. 4 is a diagram of the principle of operation of the actuating device for the tweezers.

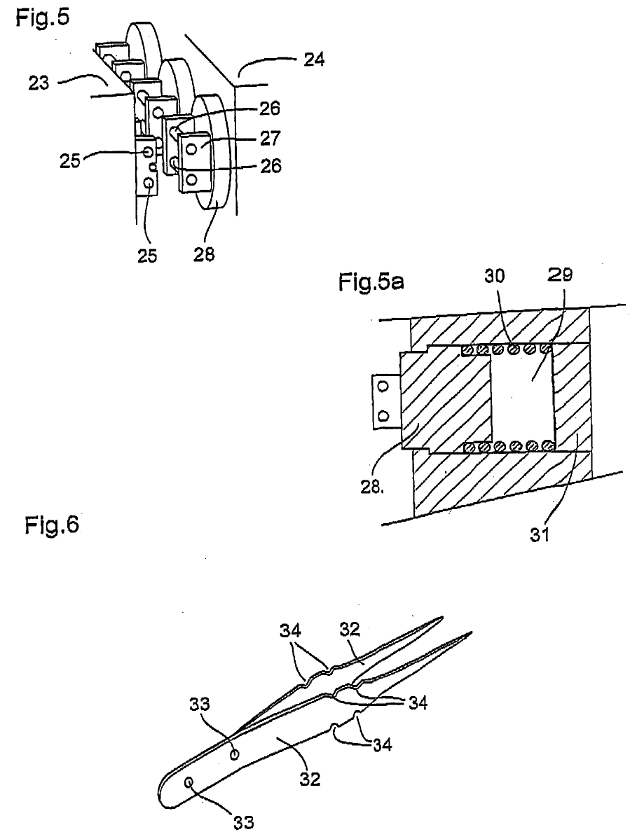

FIGS. 5 and 5a show a supply receiving the tweezers to be taken up by the tweezers holder.

FIG. 6 shows a tweezers provided for insulation in the tweezers holder.

The gripper or tweezers holder which is the object of the present invention is adapted to be mounted on the arm of a robot and to receive different tweezers according to the object to be gripped, as well as to actuate these tweezers for gripping and positioning said object.

The gripper comprises a frame or casing 1 comprising means for securement to the arm of a robot and enclosing a device 2 for securing or indexing a tweezers 3 and a device for actuating this tweezers comprising a motor 4 controlling the movements of a gripper 5 acting on the arms of the tweezers.

In the illustrated example, the securement or indexing device 2 for the tweezers is constituted by a piece 6 fixed with the help of a screw 7 on the bottom 8 of the casing 1. The piece 6 has a slot 9 disposed parallel to the longitudinal axis of the frame 1 and open in the direction of the forward open end of the frame 1. The dimensions, length, width and thickness of this slot 9 are adapted to the dimensions of the rear portion of the tweezers 3 to be fixed in the gripper.

This indexing device also comprises two holes 10 passing through one 11 of the legs of the piece 6 and in which are disposed balls 12 subject to the action of a leaf spring 13 fixed on the piece 6 with the help of a screw 14. When there are no tweezers in the indexing device, the balls 12 are applied against the internal surface of the other leg of the piece 6 under the force of the spring 13.

The tweezers adapted to be fixed in the gripper comprise on their rear portion, where the arms are connected, two holes whose interaxial distance corresponds to the interaxial distance between the holes 10 of the leg 11 of the piece 6.

During the introduction of a tweezers by its rear portion into the indexing device, the balls 12 are pressed back and then fall into the holes of the tweezers and hold the latter in the service position. The balls 12 coacting with the holes of the tweezers position the latter exactly in the gripper and hold it with sufficient force to be able to carry out with the tweezers the intended operations.

The indexing device described and illustrated is but one embodiment among many possibilities. This index device does not require any external action but it is clear that the positioning members, balls 12 and corresponding holes of the tweezers, could be different so long as they permit precise positioning and interchangeability of the tweezers. The corresponding positioning members can be made in any other known way without departing from the scope of the invention.

Similarly, the securement and indexing devices can be provided to be controlled by an external action, the gripping of the rear of the tweezers in the piece 6 being adapted to be controlled by the arrival at the end of its movement of positioning this tweezers.

The essential characteristics of this securement and indexing device are the exact positioning of the tweezers in its service position relative to the gripper and the fact that its securement will be reversible, which is to say that the tweezers will be interchangeable.

The gripper also comprises an actuating device for a tweezers 3 positioned in the fixing and indexing device described above. This actuating device comprises a motor 4 disposed in the rear of the casing 1 fixed on a cross-piece 15 having a cutout of U shape, itself disposed in the casing 1. The axle 16 of the motor 4 passes through a leg of the crosspiece 15 and is connected by a coupling 16 to the rear end of a shaft 17 whose rear end is pivoted with the help of a ballbearing 18 in the other leg of the crosspiece 15. The portion of this shaft 17 extending parallel to the longitudinal axis of the casing 1 in the direction of the securement device, is screwthreaded and coacts with a nut 19 forming the rear portion of a gripper comprising two arms 20a, 20b extending within the casing 1 on opposite sides of the securement device and each terminating in a pusher 21a, 21b emerging outside the casing 1 and each bearing on one of the legs of a tweezers positioned in the securement device.

Thus, by causing the rotation of the motor 4 in one direction or the other, the gripper is moved forward or rearward giving rise to the approach of the arms of the tweezers by the action of the pushers 21a, 21b or the spacing of these arms by their own resilient action, these arms of the tweezers always remaining in contact with said pushers 21a, 21b.

The described embodiment of the actuating device is of course a non-limiting example. In other embodiments, the kinematic connection between the shaft of the motor 4 and the pushers 21a, 21b can be very different, the gripper can be replaced by articulated levers, etc. Similarly, the motor 4 can be replaced by a jack or an electromagnet.

What is important is that the motor member, an electric motor for example of the stepping type, jack or electromagnetic, actuates the pushers which give rise to the closing movements of the arms of the tweezers and serve as an abutment for the opening of these latter against which the arms remain in bearing contact.

The control of the motor member 4 can take place electronically or by computer as a function of the program to be executed by the robot. But no matter what the control mode of this motor member, it is necessary that the latter be subject to the gripping force of the tweezers so as not to exceed a predetermined value of the gripping force of an object between the arms of the tweezers.

This subjection of the motor to the gripping force of the tweezers can be carried out with the help of four strain gauges 22 fixed on the internal surface of the arms 20a and 20b of the gripper. The strain gauges 22 are mounted in a Wheatstone bridge so as to deliver a positive voltage when these arms 20a, 20b flex outwardly in reaction to their bearing against the arms of the tweezers. This voltage increases as a function of the closing of the tweezers and then of the gripping force exerted by the latter on an object. A comparison of this positive voltage with a reference voltage corresponding to the desired gripping force, permits delivering a control signal for stopping the motor 4.

To release the object and open the tweezers, the motor is turned in the reverse direction, giving rise to the retraction of the pinchers within the casing, the tweezers open and when the latter is completely open the arms 20a, 20b of the pinchers are no longer flexed, the measuring voltage is equal to zero and causes, by comparison with another reference voltage, the stopping of the motor.

To use in an optimum way such a tweezers gripper, it is necessary that the latter, fixed to the arm of a robot, can automatically select from a supply or store of tweezers a predetermined tweezers, take it out and eventually replace it in the store.

Numerous supplies or stores can be envisaged of which one will be described below by way of example.

The positioner shown in FIGS. 5 and 5a comprises a frame comprising two blocks 23, 24 facing each other. The first block 23 comprises fixed holding members formed in this case by two pins 25 parallel to each other and relative to the surface of the block 23 to which they are fixed. The second block 24 comprises movable holding members 26 also formed by pins parallel to each other and relative to the surface of the block 24 on which they are mounted. These pins 26 are fixed between two crosspieces 27 secured to a hub 28 mounted slidably in a bore 29 of the block 24. This hub 28 is subject to the action of a spring 30 bearing on a plug 31 screwed into the block 24. In its advanced position, the hub 28 abuts against a shoulder of the bore 29.

This supply or store is adapted to hold tweezers of the type of that shown in FIG. 6. These tweezers comprise two arms 32 fixed together at one of their ends. This end comprises two holes 33 permitting the securement of the tweezers in the indexing device of the gripper by the two balls 12.

In the medial portion of the arms 32, each of these latter comprise semicircular notches 34 opening on their opposite sections. Two notches 34 per portion of each arm 32 are provided, whose interaxial distance corresponds to that of the pins 25 and 26 of the store.

To place the tweezers in the store, the tweezers is oriented in a plane parallel to the surfaces of the blocks 23, 24 carrying the pins 25, 26, then the points of the tweezers are introduced between said pins 25, 26 until the time at which the notches 34 face the pins. The tweezers is then turned by a quarter turn and the pins 25, 26 engage in the notches 32. The hub 22 recoils and then advances to hold the pins 26 applied against the sections of the arms of the tweezers.

The tweezers can then be picked up by a robot comprising the gripper. The gripper is so positioned that the rear portion of the tweezers will be introduced into the indexing device and the balls 12 coact with holes 33 of the tweezers. A rotation by a quarter turn of the tweezers, hence of the gripper, frees the pins 25, 26 from the notches 34 and the tweezers can be extracted from the store.

It should be noted that when the notches 34 of the tweezers are engaged on the pins 25, 26 of the store, the retraction of the gripper gives rise to the uncoupling of the tweezers from the indexing device by overcoming the bearing force of the balls 12.

The robot provided with a gripper can thus seek in the store the desired tweezers for a given operation, and then replace it.

The embodiment illustrated is only a particular embodiment which can be modified without departing from the scope of the claimed invention.

In one modification, the tweezers can comprise two asymmetric arms. One of the arms is flat and thick, practically indeformable, whilst the other is thin and flexible, resiliently deformable.

What remains constant in the invention, is that the tweezers comprise formations or securement means coacting with corresponding means of the securement device permitting fixing removably and in a predetermined position the tweezers on the gripper.

Moreover, the tweezers can also comprise formations adapted to coact with corresponding formations of a store or supply in which these tweezers can be interposed awaiting their coupling to the gripper.

1. Gripper for tweezers, characterized by the fact that it comprises a casing (1) adapted to be mounted on the arm of a robot, enclosing on the one hand a securing and indexing device (6-14) for a tweezers (3) and on the other hand a device for actuating the arms of the tweezers, comprising a motor member (4, 17) actuating pushers (21) acting on the arms of said tweezers.

2. Gripper according to claim 1, characterized by the fact that the casing (1) is open at one of its ends to permit the introduction of a tweezers (3) in the securing and indexing device (6-14).

3. Gripper according to claim 1 or claim 2, characterized by the fact that the securing and indexing device (6-14) comprises means (9) for positioning the rear portion of a tweezers relative to the casing (1) and temporary securement means (10, 12, 13) coacting with corresponding means (33) on the tweezers to hold the latter with a predetermined force in the securing device.

4. Gripper according to one of the preceding claims, characterized by the fact that when a tweezers is fixed and positioned in the fixing and indexing device, it extends substantially along the longitudinal axis of the gripper.

5. Gripper according to one of the preceding claims, characterized by the fact that the coupling and uncoupling of a tweezers in the gripper takes place by relative axial movement of these elements.

6. Gripper according to one of the preceding claims, characterized by the fact that the pushers (28) are constituted by the free ends of the arms (20) of a gripper, these arms (20) being fixed on a nut (19) in engagement with a screw (17) driven in rotation by a rotary motor (4).

7. Gripper according to one of the preceding claims, characterized by the fact that it comprises a control circuit for the motor member (4) given by a measuring circuit detecting the force exerted on the arms of the tweezers (3) by the pushers (21).

8. Tweezers adapted to be fixed removably on the gripper of claim 1, characterized by the fact that the rear portion of the tweezers comprises coupling formations adapted to coact with corresponding means on the securing and indexing device of the gripper.

9. Tweezers according to claim 8, characterized by the fact that it comprises a thick rigid arm and a second resiliently deformable arm.

10. Tweezers according to claim 8 or claim 9, characterized by the fact that it also comprises securement formations coacting with corresponding formations of a supply adapted for the storage of tweezers.
